(19) United States
(12) Patent Application Publication
(10) Pub. No.: US 2024/0102615 A1
(43) Pub. Date: Mar. 28, 2024

(54) METHODS OF IN SITU OPTICAL ANALYSIS OF SYRINGES AND SYSTEMS

(71) Applicant: Florida State University Research Foundation, Inc., Tallahassee, FL (US)

(72) Inventors: Brandon Alexander Krick, Tallahassee, FL (US); Kylie Van Meter, Tallahassee, FL (US)

(21) Appl. No.: 18/472,466

(22) Filed: Sep. 22, 2023

Related U.S. Application Data
(60) Provisional application No. 63/376,809, filed on Sep. 23, 2022.

(51) Int. Cl. F17C 13/02

(52) U.S. Cl. CPC F17C 13/026; F17C 2227/0353; F17C 2250/038; F17C 2250/0478; F17C 2250/0631; F17C 2250/0694; F17C 2270/02

(57) ABSTRACT

Systems and methods are provided for in situ observation of reservoirs, such as syringes, during the freeze thaw cycle to allow for more in depth understanding of the behavior of the system. The systems and methods may include an inert environment and/or a low concentration (e.g., on the order of parts per million (ppm)) of water, which may inhibit frost formation.

### CROSS-REFERENCE TO RELATED APPLICATION

This application claims the benefit of U.S. Provisional Application Ser. No. 63/376,809, filed Sep. 23, 2022, the disclosure of which is hereby incorporated by reference in its entirety, including all figures, tables, and drawings.

### BACKGROUND

During the freezing and thawing of prefilled reservoirs, such as syringes, expansion and contraction of the liquid in the syringe can cause movement of the stopper. This movement can be on the order of tens of micrometers to a few millimeters and can compromise the sterility of a syringe (for example, by exposing sterile regions to nonsterile regions).

During cryostorage, syringes can be subjected to a variety of temperatures, including temperatures that can cause frost to form on surfaces, thereby inhibiting visibility of the syringes and their internal components. Syringes also can be subjected to a variety of environmental changes, such as pressure changes, especially during shipment.

### BRIEF SUMMARY

In view of the above, there remains a need in the art for systems and methods for observing reservoirs, such as syringes, including systems and methods for observing the in situ movement of stoppers and fluids, effect of temperature and/or pressure changes, loss of contact among components of reservoirs, and other characteristics. Embodiments of the subject invention relate to the imaging and analysis of reservoirs, including the in situ imaging and analysis of reservoirs, such as syringes.

Embodiments of the subject invention provide novel and advantageous systems and methods for in situ observation of reservoirs, such as syringes, during the freeze thaw cycle to allow for more in depth understanding of the behavior of the system. They may be performed in an inert environment and/or with a low concentration (e.g., on the order of parts per million (ppm), such as less than 100 ppm) of water, which may inhibit frost formation.

In an embodiment, a system (for in situ observation of reservoirs, such as syringes, and such as during the freeze thaw cycle to allow for more in depth understanding of the behavior of the system) can comprise: a reservoir configured to retain a fluid (and/or actually retaining the fluid); a lens disposed adjacent the reservoir; a temperature controller configured to modify a temperature of the reservoir, the fluid, or both; and a heat exchanger configured to house at least one of the reservoir and the temperature controller (and/or housing at least one of the reservoir and the temperature controller). The system can further an apparatus configured to move (and/or actually moving) the lens relative to the reservoir. The apparatus can comprise a linear stage. The apparatus can be configured to facilitate observation at different focal distances from the reservoir, different focal planes within the reservoir, or both. The system can further comprise at least one additional reservoir. The at least one additional reservoir can be housed by the heat exchanger and/or the heat exchanger can be configured to house the at least one additional reservoir. The temperature controller can be configured to maintain a temperature of the reservoir and/or the fluid, or modify a temperature of the reservoir and/or fluid at a (predetermined) rate. The temperature controller can be, for example, a proportional, integral, derivative (PID) temperature controller. The PID temperature controller can comprise inline heaters configured to control the cooling and heating rates of the system and/or maintain a temperature of the system. The system can further comprise a thermocouple. The thermocouple can be configured to measure (and/or can actually measure) a temperature of the reservoir and/or the fluid in the reservoir. The reservoir can comprise a syringe. The heat exchanger can be configured to (and/or can actually) achieve and/or maintain a temperature of the reservoir that is suitable for storage of the reservoir's contents. The heat exchanger can be configured to (and/or can actually) cool the reservoir using a coolant (e.g., liquid nitrogen, water, air, a cryogen, or a refrigerant. The reservoir's contents can include, and/or the fluid can be, a biologic, a vaccine, or a combination thereof. The system can further comprise memory configured to store (and/or actually be storing) computer-executable instructions; and at least one computer processor configured to access (and/or actually be accessing) the memory and execute (and/or actually be executing) the computer executable instructions. The lens can be a component of an image sensor (e.g., a camera). The camera can be configured to observe the reservoir through a cryostat viewing port. The camera can have an adjustable focal distance. The heat exchanger can be configured to (and/or can actually) house the temperature controller.

In another amendment, a method of monitoring a reservoir (e.g., a syringe) can comprise: A) providing a system as disclosed herein; B) collecting two or more images of the reservoir with the lens, comparing the two or more images to determine a change of (i) a position or a movement of one or more components of the reservoir and/or the fluid in the reservoir, (ii) a phase transformation of the fluid, (iii) a reduction or a loss of contact among a reservoir and one or more components of the reservoir, or (iv) a combination thereof; C) collecting a temperature of the fluid in the reservoir, the reservoir, one or more components of the reservoir, or a combination thereof at two or more times, and comparing the temperatures; or D) a combination thereof. The reservoir can comprise a syringe, and the one or more components of the reservoir can comprise a stopper. The reservoir and/or the fluid can be at a temperature of, for example, −100° C. or less, or can be cooled to a temperature of −100° C. or less before, during, and/or after the performance of steps B) and/or C). The system can be subjected to changes in external pressure before, during, and/or after the performance of steps B) and/or C). The two or more images can be collected at multiple focal planes. The collecting of the two or more images or the temperature can generate data stored in at least one computer memory configured to store computer-executable instructions. The method can further comprise accessing the at least one computer memory and, via at least one computer processor, executing instructions to operate one or more components of the system. The instructions can operate a temperature controller. The collecting of the two or more images and the temperatures at the two or more times can occur simultaneously.

### DETAILED DESCRIPTION

Embodiments of the subject invention provide novel and advantageous systems and methods for in situ observation of reservoirs, such as syringes, during the freeze thaw cycle to allow for more in depth understanding of the behavior of the system. They may be performed in an inert environment and/or with a low concentration (e.g., on the order of parts per million (ppm), such as less than 100 ppm) of water, which may inhibit frost formation.

In some embodiments, systems and methods can allow for the in situ imaging of reservoirs (e.g., syringes and similar devices) and/or thermal cycling of reservoirs (e.g., syringes and similar devices) ranging from cryostorage temperatures (e.g., −100° C. or less) to high temperatures (e.g., 100° C. or greater).

In some embodiments, through adaptive optics, multiple focal planes can be imaged, thereby permitting imaging of a stopper-reservoir interface (e.g., stopper-glass interface), the frozen liquid surface, etc. System temperature control can allow for the specified cooling and heating rates in the systems to be tested.

In some embodiments, a system can include, or a method can be performed in, an inert environment chamber with a low concentration (e.g., on the order of parts per million (ppm), such as less than 1,000 ppm, less than 100 ppm, or less than 10 ppm) of water to inhibit frost from forming on the glass, thereby allowing for visibility into the reservoir (e.g., syringe). The temperature of the entire system, fluid in a reservoir, stopper, etc. can be actively monitored and recorded. Images taken with an image sensor (e.g., a camera) can be synced to temperature data collected, allowing for comprehensive analysis of syringe internals during cryostorage. This analysis may include stopper location, optical artifacts that indicate loss of contact or sealing, phase transformations, and/or other optically observable phenomena. Additional peripherals can be added to measure leakage and leakage rates, stopper friction, etc. Additionally, the atmospheric pressure around the reservoir (e.g., syringe) and internal pressure within the reservoir (e.g., syringe) can be controlled with external subsystems.

In some embodiments, systems and methods can be used for the validation of reservoirs (e.g., syringes) to be stored in cold environments (e.g., down to −100° C. or less) or pressure cycled (for example, pressure cycling observed during air transport). Stopper movement can be tracked, and temperatures of the system, stopper, and/or internal fluid (e.g., liquid) can be measured simultaneously. Images at multiple focal planes can be taken during testing. Phase transformations of various components can be measured optically and with changes in temperature/heat transfer (endotherms/exotherms).

Systems and methods of embodiments of the subject invention can be used to research and/or validate prefilled reservoirs (e.g., syringes) in cryostorage conditions, thermal cycling, and/or pressure cycling.

In some embodiments, a system can include a reservoir configured to retain a fluid. The reservoir may be, or may be a component of, any device, such as a syringe. The syringe may include any components of known syringes, such as a stopper/plunger, a tip (e.g., a mixing tip), a threading to a receive a tip or needle, etc. In some embodiments, the system can include at least one additional reservoir. That is, the system can include two or more reservoirs, such as at least 5, at least 10, at least 25, at least 50, or more reservoirs (e.g., syringes). This plurality of reservoirs may be monitored according to the methods described herein.

Any fluid may be present in the reservoir. The fluid may be in a liquid phase, a gas phase, or a combination thereof. In some embodiments, the fluid includes a biologic, a vaccine, or a combination thereof. For example, a fluid may be a vaccine, or a vaccine may be dispersed in the fluid.

In some embodiments, the system can include a lens, such as a lens of an image sensor (e.g., a camera). The lens may be arranged adjacent the reservoir. For example, a lens may be arranged at a position effective to collect images of one or more reservoirs and/or fluids of a system. The system can include an apparatus configured to move the lens (e.g., of the image sensor, such as a camera) relative to the reservoir. The apparatus can include, for example, a linear stage, but other apparatuses are envisioned. The apparatus can be configured to facilitate observation at different focal distances from the reservoir, different focal planes within the reservoir, or a combination thereof.

In some embodiments, the system can include a temperature controller. The temperature controller can be configured to modify a temperature of the one or more reservoirs of the system. For example, the temperature controller can be configured to maintain a temperature of one or more reservoirs, or modify the temperature of the one or more reservoirs at a rate, such as a predetermined ramp rate. The temperature controller can include any of those known in the art. In some embodiments, the temperature controller is a proportional, integral, derivative (PID) temperature controller. The PID temperature controller can include inline heaters configured to control the cooling and heating rates of the system and maintaining temperature of the system.

In some embodiments, the system can include a heat exchanger. The heat exchanger can be configured to house one or more of the reservoirs of the system. The heat exchanger, additionally or alternatively, can be configured to house a temperature controller. The heat-exchanger can be configured to achieve or maintain a temperature of the reservoir that is suitable for storing of the reservoir's contents (e.g., a cryostorage temperature as described herein). In some embodiments, the heat exchanger is configured to cool the reservoir using a coolant. Any coolant known in the art may be used, including, but not limited to, liquid nitrogen, water, air, a cryogen, or a refrigerant to cool the reservoir.

In some embodiments, the system can include at least one thermocouple. The thermocouple can be configured to measure a temperature of the system or the reservoir, such as a fluid in a reservoir.

In some embodiments, the system can include memory configured to store computer-executable instructions, and at least one computer processor configured to access the memory and execute the computer executable instructions to: (i) collect, store, generate, and display data, such as images collected by a lens/camera, temperatures collected by a thermocouple, measurements of movements of a component of a reservoir or fluid; and/or (ii) operate one or more mechanical and electrical components of the system, including valves and actuators, switches, resistive heating elements, and the like used to control the heat exchangers, cameras, lens, etc. The at least one computer processor can collect, store, and/or generate data, such as images collected by a lens/camera, temperatures collected by a thermocouple, measurements of movements of a component of a reservoir or fluid, comparative data, correlative data (e.g., pressure versus temperature, temperature versus movement of a component, temperature versus phase transformation, as determined by images), etc. The at least one computer processor can be in operable communication with a display device (e.g., a display such as a monitor or smart device display). Based on data collected from one or more elements of a system and/or user input, a processor can be configured to send instructions to one or more components of the systems described herein, such as a temperature controller, heat exchanger, etc. For example, a thermocouple can report temperature data to a processor, and, in turn, the processor can forward instructions to a temperature controller to increase or decrease the temperature of the reservoirs.

In some embodiments, the system includes one or more peripheral devices configured to: (i) measure one or more of leakage (e.g., fluid leakage), leakage rate, stopper friction, etc.; and/or (ii) monitor and/or control atmospheric pressure around the reservoir and/or internal pressure within a reservoir.

In some embodiments, a method can include: A) providing a system as described herein; B) collecting two or more images of the reservoir with the lens, comparing the two or more images to determine a change of (i) position or a movement of one or more components of the reservoir and/or the fluid in the reservoir, (ii) a phase transformation of the fluid, (iii) reduction or loss contact among a reservoir and one or more components of the reservoir, or (iv) a combination thereof; C) collecting a temperature of the fluid in the reservoir, the reservoir, one or more components of the reservoir, or a combination thereof at two or more times, and comparing the temperatures; and/or D) a combination thereof. The two or more images may be collected at the two or more times the temperature is collected, thereby allowing a condition of the reservoir to be observed/compared/analyzed at the different temperatures.

During the method, the reservoirs may be at any temperature and/or pressure. The temperature, pressure, or a combination thereof may be static or dynamic. For example, the method may be performed before, during, or after a reservoir and its contents are cooled to a temperature suitable for cryostorage, thawed/heated after removal from cryostorage, heated to a relatively high temperature (e.g., 100° C. or greater), exposed to different pressures (e.g., pressures similar to those imparted by shipping in an airplane), or a combination thereof. In some embodiments, the reservoirs are at or cooled to a temperature of −100° C. or less, which is suitable for cryostorage. In some embodiments, the reservoirs are at or heated to a temperature of at least 100° C. In some embodiments, the methods described herein are applied during at least a portion of the freeze thaw cycle.

Systems and methods of embodiments of the subject invention can be used to determine modifications to a reservoir or its contents caused by changes in any environmental elements, including, but not limited to, pressure, humidity, temperature, etc.

In some embodiments, the system can subjected to changes in external pressure before, during, and/or after the performance of steps B) and/or C).

In some embodiments, the method is performed in an inert environment. The inert environment can be provided by a chamber with a low concentration (e.g., on the order of ppm, such as less than 1,000 ppm) of water to inhibit frost from forming on the glass, thereby allowing for visibility into the syringe. The temperature of the entire system, fluid in a reservoir, stopper, etc. can be actively monitored and recorded during the methods described herein.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

The terms “a,” “an,” and “the” are intended to include plural alternatives, e.g., at least one. For instance, the disclosure of “an antisolvent”, “a triaryl amine”, and the like, is meant to encompass one, or mixtures or combinations of more than one antisolvent, triaryl amine, and the like, unless otherwise specified.

Various numerical ranges are disclosed herein. When a range of any type is disclosed or claimed herein, the intent is to disclose or claim individually each possible number that such a range could reasonably encompass, including end points of the range as well as any sub-ranges and combinations of sub-ranges encompassed therein, unless otherwise specified.

When ranges are used herein, combinations and subcombinations of ranges (e.g., any subrange within the disclosed range) and specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A system, comprising:
a reservoir configured to retain a fluid;
a lens disposed adjacent the reservoir;
a temperature controller configured to modify a temperature of the reservoir, the fluid, or both; and
a heat exchanger configured to house at least one of the reservoir and the temperature controller.

2. The system according to claim 1, further comprising an apparatus configured to move the lens relative to the reservoir.

3. The system according to claim 2, wherein the apparatus comprises a linear stage.

4. The system according to claim 2, wherein the apparatus is configured to facilitate observation at different focal distances from the reservoir, different focal planes within the reservoir, or both.

5. The system according to claim 1, wherein the system comprises at least one additional reservoir housed by the heat exchanger.

6. The method according to claim 1, wherein the temperature controller is a proportional, integral, derivative (PID) temperature controller comprising inline heaters configured to: control cooling and heating rates of the system; maintain a temperature of the system; or both.

7. The system according to claim 1, further comprising a thermocouple configured to measure a temperature of the reservoir, the fluid, or both.

8. The system according to claim 1, wherein the reservoir comprises a syringe.

9. The system according to claim 1, wherein the heat exchanger is configured to achieve or maintain a temperature of the reservoir that is suitable for storage of the reservoir's contents.

10. The system according to claim 1, wherein the heat exchanger is configured to cool the reservoir using a coolant.

11. The system according to claim 1, wherein the reservoir contains a biologic, a vaccine, or a combination thereof.

12. The system according to claim 1, further comprising:
memory having computer-executable instructions stored thereon; and
a processor in operable communication with the memory and configured to access the memory and execute the computer-executable instructions.

13. The system according to claim 1, wherein the lens is a component of a camera configured to observe the reservoir through a cryostat viewing port.

14. The system according to claim 13, wherein the camera has an adjustable focal distance.

15. A method of monitoring a reservoir, the method comprising:
A) providing the system according to claim 1; and
B) at least one of the following steps:
B1) collecting two or more images of the reservoir with the lens, comparing the two or more images to determine a change of (i) a position or a movement of one or more components of the reservoir, the fluid in the reservoir, or both, (ii) a phase transformation of the fluid, (iii) a reduction or a loss of contact among a reservoir and the one or more components of the reservoir, or (iv) a combination thereof; and
B2) collecting a temperature of the fluid in the reservoir, the reservoir, one or more components of the reservoir, or a combination thereof at two or more times, and comparing the temperatures.

16. The method according to claim 15, wherein the reservoir comprises a syringe, and the one or more components of the reservoir comprises a stopper.

17. The method according to claim 15, wherein at least one of the reservoir and the fluid is at, or cooled to, a temperature of −100° C. or less before, during, and/or after the performance of step (B).

18. The method according to claim 15, wherein the system is subjected to changes in external pressure before, during, and/or after the performance of step (B).

19. The method of claim 15, wherein the two or more images are collected at multiple focal planes.

20. The method according to claim 15, wherein the collecting of the two or more images or the temperature generates data stored in at least one computer memory configured to store computer-executable instructions,
wherein the method further comprises accessing the at least one computer memory and, via at least one computer processor, executing instructions to operate one or more components of the system, and
wherein the instructions operate the temperature controller.
